(19) United States
(12) Patent Application Publication
(10) Pub. No.: US 2004/0102195 A1
(43) Pub. Date: May 27, 2004

(54) Broadcasting in a communication system

(76) Inventors: Siamak Naghian, Espoo (FI); Jan Kall, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/363,394

(22) PCT Filed: Aug. 31, 2001
(86) PCT No.: PCT/EP01/10169

(30) Foreign Application Priority Data
Sep. 1, 2000 (GB) 0021544.2

(51) Int. Cl. H04Q 7/20

(52) U.S. Cl. 455/456.1; 455/433; 455/422.1

(57) ABSTRACT

The present invention relates to a communication system provided with a plurality of access entities. The access entities are for provision of wireless communication for stations within the service area thereof. The communication system comprises a broadcasting element adapted to control broadcasting within at least one of the access entities and a location service function. The location service function is adapted to generate and process information that associates with the location of a station. The location service function and the broadcasting element may interact with each other. The arrangement is such that the broadcasting element is enabled to broadcasts in selected access entities based on information communicated between the location service function and the broadcasting element

### FIELD OF THE INVENTION

The present invention relates to broadcasting, and in particular, but not exclusively, to broadcasting in a communication system provided with a location service function.

### BACKGROUND OF THE INVENTION

Communication networks are known. Communication networks typically operate in accordance with a given standard or specification which sets out what the various elements of the network are permitted to do and how that should be achieved, i.e. the technology on which the communication is based on. A communication network is a cellular radio network consisting of access entities referred to as cells. A feature of the cellular system is that it provides mobility for the mobile stations, i.e. the mobile stations are enabled to move from a location area to another (e.g. when the mobile station moves i.e. roams from a cell to another cell) and even from a network to another network that is compatible With the standard the mobile station is adapted to.

As mentioned above, an access entity may be formed by a cell. The cell can be defined as a certain area covered by a base transceiver station (BTS) serving user equipment (UE) via a wireless interface. The base station forms a part of an radio access network (RAN). Several cells may cover a larger service area than one cell. It should be appreciated that the size of the location area/routing area where the mobile station may be paged depends on the system and circumstances. However, the paging area cannot typically be smaller than one cell.

Examples of the different cellular standards and/or specifications include, without limiting to these, GSM (Global System for Mobile communications) or various GSM based systems (such as GPRS: General Packet Radio Service), EDGE (Enhanced Data rate for GSM Evolution), AMPS (American Mobile Phone System), DAMPS (Digital AMPS), WCDMA (Wideband Code Division Multiple Access) or CDMA (Code Division Multiple Access) or TDMA (Time Division Multiple Access) based 3^{rd} generation telecommunication systems such as the Universal Mobile Telecommunication System (UMTS), i-Phone, and IMT 2000 (International Mobile Telecommunication System 2000) and so on. It should be appreciated that the terminology used in the different standards may vary from each other. For example, the 3G specifications define “service area” and “service area identity” concepts which can be seen as corresponding features to the “cell” and “cell identity” concepts used in the GSM specifications.

The user equipment (UE) within one of the access entities (such as the cells or other service areas) of the communication system may be controlled by one or several controllers. Examples of the controller nodes include radio network controllers such as a base station controller (BSC) of the GSM system or a radio network controller (RNC) of the 3^{rd} generation systems and core network controllers such as a mobile switching center (MSC) of the GSM system and a serving GPRS support node (SGSN). Other control nodes may also be implemented in the network. The controller can be connected further to a gateway or linking node, for example a gateway GPRS support node (GGSN) or gateway mobile switching center (GMSC), linking the controller nodes to other parts of the communication system and/or to other communication networks, such as to a PSTN (Public Switched Telecommunications Network) or to a data network, such as to a X.25 based network or to an IP (Internet Protocol) based data network. The network may also include nodes for storing information of mobile stations subscribing the network or visiting the network, such as appropriate home location registers (HLR) and visitor location registers (VLR). Depending the implementation, the register nodes may be integrated with a control node.

In a mobile communication network it is also possible to produce geographical location information that associates with a mobile station and thus the user thereof. The positioning can be accomplished by various different techniques. For example, substantially accurate geographical location information that associates with a user equipment can be obtained based on the known satellite based GPS (Global Positioning System). More accurate location information can be obtained through differential GPS. A possibility is to use a location service that associates with a cellular telecommunications system for the provision of the location information. In this approach the cells or similar geographically limited radio access entities and associated controllers of the telecommunication system can be utilised to produce at least a rough location information estimate concerning the current location of the mobile user equipment or station, as the cellular telecommunications system is aware of the cell or service area with which the user equipment currently associates. The cellular system may be provided with location measurement units (LMU) that provide more accurate data concerning the location of a mobile user equipment within the service area of the cellular system. The LMU may be adapted to measure the real time differences in the signalling timing of different base stations. The information regarding the real time differences may be then used as assistance data in the mobile station based location determinations. It is also possible to conclude geographical location when the mobile station/user equipment is located within the coverage area of a visited or “foreign” network. The visited network may be made capable of transmitting the location of the mobile user equipment back to the home network, e.g. to support location services or for the purposes of routing and charging.

The location data that is provided by means of the elements of the cellular system may be processed in a specific location service node that is implemented either within the cellular system or connected thereto. The location data may also be processed in a mobile station that is provided with appropriate processing capacity. The location service facility provided by the communication system may serve different clients via an appropriate interface. The location information may be used for various purposes, such as for location of a mobile telephone that has made an emergency call or for locating vehicles or particular mobile stations and so on.

The positioning methods supported for example in the proposed third generation systems generally consist of network-based and/or mobile station based location methods depending on the network element that perform the necessary measurements for the positioning and the element that performs the final positioning calculations.

It is also possible to use a combination of the different location information provision approaches. For example, the network may assist the mobile station in determining its position by providing the mobile station with assistance data, such as the position and real time differences of associated base stations. The same approach may be applied in the network based positioning, that is, the mobile station may assist the network by providing appropriate measurement results thereto.

With regard to the terminology it should be appreciated that the network typically, although not necessarily in all standards, transmits so called LCS assistance data, where after the mobile station may use the assistance data to generate more precise measurement results or to improve mobile station based location calculations. The mobile station may send data called “location information” or “LCS data”, e.g. information about the measurement results or its own calculated position to the network.

Data can be broadcast by applying an appropriate Radio Resource Control (RRC) procedure, such as the system information broadcasting procedure. However, if there is a substantially great number of mobile stations to be positioned, the network may not provide enough resources for this purpose. This may be problematic e.g. since the RRC connection is typically a per cell connection. If the assistance data should be broadcast to several cells that may be controlled by different access radio network controllers (such as the RNC), the per cell type of operation would mean a great number of connections at the same time, thus consuming the resources of the cellular communication system.

Despite the requirement of additional resources, the inventors believe that the location service function will form an important feature of the future telecommunications networks, such as the third generation (3G) systems. In addition to the location services, a function referred to as cell broadcasting (CB) is also believed to become an important application of the networks. In brief, cell broadcasting stands for a function by means of which information can be broadcast in a cell (or a group of cells) to all user equipment within the cell. For example, in the 3G UMTS information may be broadcast to mobile stations over a broadcast channel (BCCH). The cell broadcasting may be controlled by a Cell Broadcasting Centre (CBC). The location services and broadcasting services have been described e.g. in 3G technical specifications describing different aspects of said features in more detail. The specifications include 3G specifications TS 22.071 titled ‘LCS Service description’ (Release 1999), TS 23.171 titled ‘Functional stage 2 description of location services in UMTS (Release 1999)’ describing system and core network aspects of the LCS, TS 25.305 titled ‘Stage 2 Functional Specification of Location Services in UTRAN (Release 1999)’, and TS 25.324 titled ‘Radio Interface for Broadcast/Multicast Services’ (Release 1999). These four documents are incorporated herein by reference.

The inventors have also found that there are many cell broadcast applications that could be implemented and/or improved if they could be provided with information associated with the location of the mobile station. The mobile station location data, however, is not readily available e.g. in the cell broadcast controller element. Instead, the location data is typically available only in network elements such as the radio network controller, the serving mobile location center (SMLC) or the gateway mobile location center (GMLC), i.e. in elements that currently serve the particular mobile station and where the actual location service entities are located.

### SUMMARY OF THE INVENTION

Embodiments of the present invention aim to address one or several of the above problems.

According to one aspect of the present invention, there is provided a method in a communication system provided with a plurality of access entities for provision of wireless communication for stations within the service area of the access entities, and a broadcasting element adapted to control broadcasting within at least one of the access entities, the method comprising: generating information that associates with the location of a station and processing said location information in a location service function; communicating information between the location service function and the broadcasting element; and broadcasting in selected access entities based on information communicated between the location service function and the broadcasting element.

According to another aspect of the present invention there is provided a communication system, comprising: a plurality of access entities providing wireless communication facility for stations; a broadcasting element adapted to control broadcasting within at least one of the access entities; a location service element that associates with a controller adapted to control at least one access entity for processing information that associates with location of a station; and means adapted to communicate information between the location service element and the broadcasting element, wherein the communication system is arranged to broadcast in selected access entities based on the information that has been communicated between the location service element and the broadcasting element.

According to another aspect of the present invention there is provided an arrangement for a communication system comprising: a first client for use in a broadcasting element of the communication system for enabling a location service function of the communication system to access the broadcasting element; and a second client for use in the location service function for enabling the broadcasting element to access the location service function, wherein the clients enable interaction between the location service function and the broadcasting element over an interface there between.

The embodiments of the invention may save network resources. The saved resources may be used for other purposes. The location service assistance data may be broadcast over a wide geographical area of the radio network, even within the service area of different radio access network controllers. The cell broadcast services may be improved and made more advanced based on the available location data of the mobile station in a serving control node or a gateway location service node. The embodiments may be applied to the already specified systems without substantial additional cost and complexity. The interoperation between the location service and cell broadcast mechanisms of the embodiments may be utilised during the network planning process for optimising the usage of radio resources in the system.

### BRIEF DESCRIPTION OF DRAWINGS

For better understanding of the present invention, reference will now be made by way of example to the accompanying drawings in which:

FIG. 1 shows a network architecture that may be used in embodiments of the present invention;

FIG. 2 is a signalling chart illustrating two embodiments of the present invention;

FIG. 3 is a flowchart illustrating the operation of an embodiment of the present invention;

FIGS. 4 to 8 illustrate possible applications of the interaction between the broadcasting function and the location service in accordance with the present invention; and

FIG. 9 shows an embodiment where the communication system comprises different communication networks.

### DESCRIPTION OF PREFERRED EMBODIMENTS OF THE INVENTION

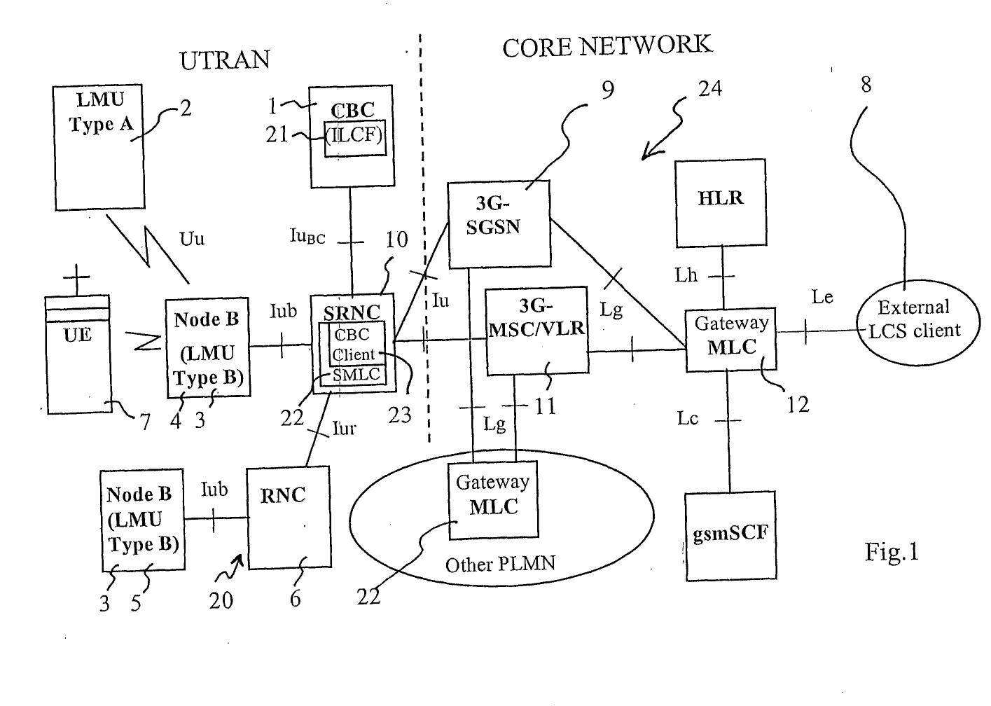

Before explaining the preferred embodiments of the invention in more detail, a reference is made to FIG. 1 which is a simplified presentation of a cellular system that is provided with a location services function and in which the embodiments of the invention may be employed. It should be appreciated that even though the exemplifying telecommunications network shown and described in more detail uses the terminology of 3G WCDMA (Wideband Code Division Multiple Access) UMTS (Universal Mobile Telecommunications System) public land mobile network (PLMN), the proposed solution can be used in any system providing communications between a mobile station and a base station and some kind of location information service.

FIG. 1 shows base stations 4 and 5. It should be appreciated that in some systems, such as in the systems providing 3^{rd} generation telecommunication services, the base station may be referred to as Node B. For clarity reasons this specification will use the term base stations for all kinds of stations that are capable of transmitting signals towards and/or receiving signals from a user equipment 7. More particularly, each base station 4, 5 is arranged to transmit signals to and receive signals from a mobile user equipment (UE) 7 via wireless communication. Likewise, the mobile user equipment 7 is able to transmit signals to and receive signals from the respective base station. The mobile user equipment will be referred to in the following as mobile station (MS). Typically a number of mobile stations will be in communication with each base station although only one mobile station 7 is shown in FIG. 1 for clarity.

The base stations 4 and 5 are connected each to a controller node 10 and 6, respectively. In the exemplifying PLMN system the base station 4 is connected to a serving radio network controller (SRNC) 10 of a UMTS terrestrial radio access network (UTRAN) 20. The SRNC 10 may be arranged to store user information and system information. It should be appreciated that typically more than two radio network controllers are provided in a cellular network.

In addition the radio access network 21, the cellular network may comprise a core network (CN) 24. The radio network controller 10 may be connected to appropriate core network entities of the cellular system, such as a MSC (mobile switching centre) 11 and/or SGSN (serving general packet radio service support node) 9, via a suitable interface arrangement. The interface may be, for example, an lu interface.

The SRNC 10 of FIG. 1 is provided further with a location service function 22. This function may be referred to a serving mobile location entity. The location service feature will be described in more detail after the following brief description of the mobility of the mobile station 7.

The mobile station 7 is enabled to move within the base station coverage area and also from one base station coverage area to another coverage area. The location of the mobile station 7 may thus vary in time as the mobile station is free to move from one location (base station coverage area or cell coverage area) to another location (to another coverage area) and also within one coverage area. The geographical location of a mobile station may be defined on the basis of the position of the mobile station relative to the base station(s) of the mobile telecommunications network.

The geographical location of the base station and/or the mobile stations may be defined, for example, in X and Y co-ordinates or in latitudes and longitudes. A possibility is to use the relation between defined radiuses and angles, e.g. based on the spherical coordinate system or alike. It is also possible to define the location of the base stations and/or mobile stations in vertical directions. For example, Z coordinate may be used when providing the location information in the vertical direction. The vertical location may be needed e.g. in mountainous environments or in cities with tall buildings.

FIG. 1 also shows elements adapted to provide location services for different applications or clients. A location service element is typically adapted to process information that associates with the location of the mobile station in order to determine the geographical location of the mobile station. The client may be an external client or an internal clients. The internal client may comprise the elements of the PLMN system itself.

More particularly, FIG. 1 shows a serving mobile location center (SMLC) 22 and a gateway mobile location center (GMLC) 12. Both of these two elements or nodes may be used for the provision of the location services function. A difference between the functions of the GMLC 12 and the SMLC 22 is that the GMLC provides means for the external LCS clients 8 (only one client shown for clarity) to access to the location service system while the SMLC 22 is responsible for overall operation of the location service (such as location calculations, handling positioning methods and algorithms, and so on).

In FIG. 1 the LCS nodes are arranged to receive predefined information concerning the location of the mobile station 7 via appropriate interface means from the cellular system. The serving location service node 22 is implemented in the radio access network side 20 of the system. The node 22 is arranged to receive location information directly from the radio access network controller 10. The gateway location service node 12 is implemented in the core network 24 of the system. The node 12 is arranged to receive location information from the radio access network 20 via the MSC 11 and/or SGSN 9 connected by the appropriate interface means to the access network 20. The positioning information is obtained using one or more of the appropriate techniques some of which will be briefly discussed below or any other suitable technique. This information may be processed in a predefined manner and is then provided to the internal or external clients.

According to an embodiment the mobile station 7 is provided with a location information processing function. The mobile station 7 is capable of generating and transporting location information thereof to the other network elements. The mobile station 7 may be provided with terminal equipment apparatus (either integrated in the mobile station device or connected thereto). The location information may be based on use of information provided by system that is separate from the communication system, such as by means of the Global Positioning System (GPS) or similar.

More precise location measurement data may be measured by means of one or several location measurement units (LMU) 2 and 3. A cellular network, such as for example a WCDMA network may not be synchronised. Thus the Real Time Difference (RTD) between the different base stations must be known in order to be able to locate a mobile station MS based on OTDOA (Observed Time Difference of Arrival) measurements. The RTD values are typically measured by OTDOA Location Measurement Units located in the network (this is equal in function to a EOTD LMU in the GSM). Therefore an implementation of an Observed Time Difference of Arrival (OTDOA) method for the Location Services (LCS) in a WCDMA network may require use of the location measurement units (LMUs) or similar entities. A LMU may be positioned either independently from the base station sites or co-site with a base station BTS. It should be appreciated that it is possible to dispose the units in a remote location and to connect the units to the respective base station or several base stations by an appropriate communication media such as by cabling or a suitable wireless connection. In FIG. 1 a type A LMU 2 is connected by a wireless connection to the base station 4, whereas a Type B LMU 3 is integrated with the base station site and has a fixed connection with the base station 4.

FIG. 1 shows also a broadcasting element that will be referred to in this description as a cell broadcasting centre (CBC) 1. The general principles and operation of a conventional cell broadcasting service and the elements thereof are explained in more detail e.g. in 3^{rd} Generation Partnership Project (3GPP) specification TS 23.041 ‘Technical realization of Cell Broadcast Service (CBS)’. This specification is incorporated herein by reference.

In the illustrated architecture the CBC 1 and SRNC 10 are connected to each other through an IU_{CB} interface. The IU_{CB} is specified in detail in the related cell broadcasting (CB) specifications, such as in 3GGP Technical Specification No. TS 25.324 titled ‘Radio Interface for Broadcast/Multicast Services’. This specification is also incorporated herein by reference.

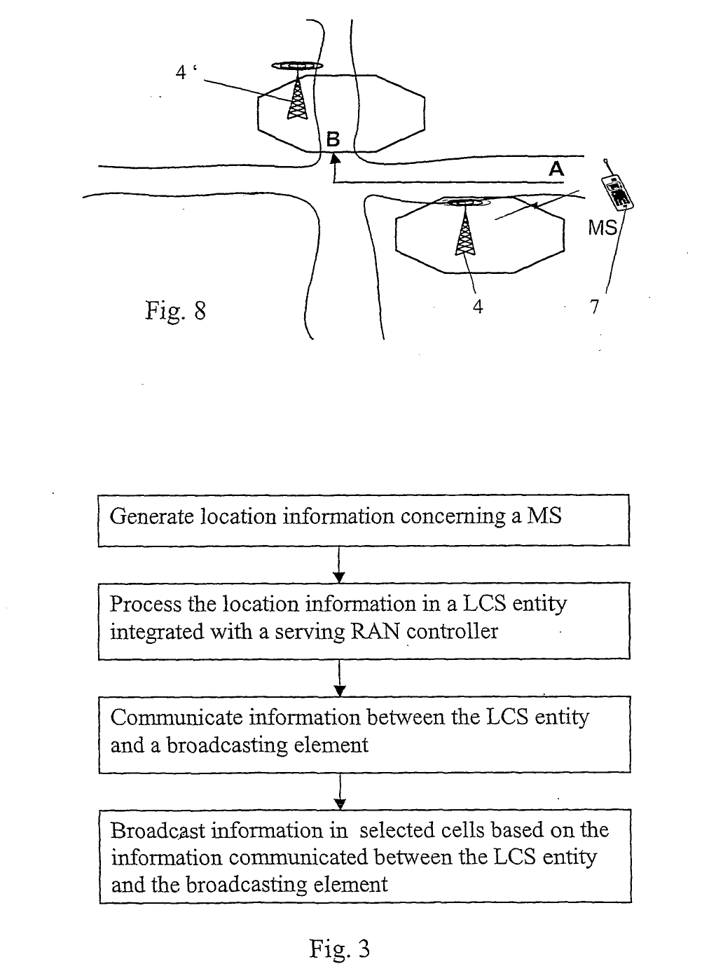

Possible uses of the CBC function in accordance with the principles of the present invention will now be explained in more detail. The embodiments aim to provide interoperation between the location services (LCS) and cell broadcast (CB) functions. As shown by the flowchart of FIG. 3, the LCS function generates and processes information that associates with the location of a mobile station. information may be communicated between the LCS function and the broadcasting functions. The system is adapted to broadcast in selected cells based on information communicated between the location service function and the broadcasting function. It should be appreciated that said information communicated between the two functions may be used only as an additional information for the selection of the cells and that other information may also be used as a base for the selection. The following exemplifying embodiments will clarify this interoperation between and give examples of how the interoperation may be made feasible.

In accordance with an embodiment appropriate clients 21, 23 may be used to enable interaction between the elements 1 and 22 of the network. An internal LCS client (ILCF) 21 is integrated in the CBC 1. Correspondingly, an internal cell broadcasting (CB) 23 client may be integrated in the SRNC element 10, and more particularly, within a serving mobile location centre entity 22 of the controller 10. In other words, by means of the clients 21,23 the CBC and SRNC network elements 1,10 may both access the mobile location data and the CB services.

An appropriate client may be in the form of an object that enables a first network element to access services provided by a second element, said client being implemented in said second element. For example, a CB client may be a CB user interface and the location services client may be a LCS user interface. Use of clients as such is specified for the CB and LCS functions in the related technical specifications, and therefore the proposed inter-mode LCS-CB operation may set any additional requirements to the system. However, some specific communication applications may require adaptation to enable the use of the embodiment.

Although not explicitly shown in FIG. 1, if the CBC function is located at the core network side 24 of the communication system (as is typical in the prior art), it is possible that the CBC may also be connected with the gateway mobile location center (GMLC) 12 also located at the core network side of the system. The cell broadcasting center (CBC) may be located at the core network side for example in the 3G systems. This implementation may make it possible for the CBC to have an access to location services through the GMLC.

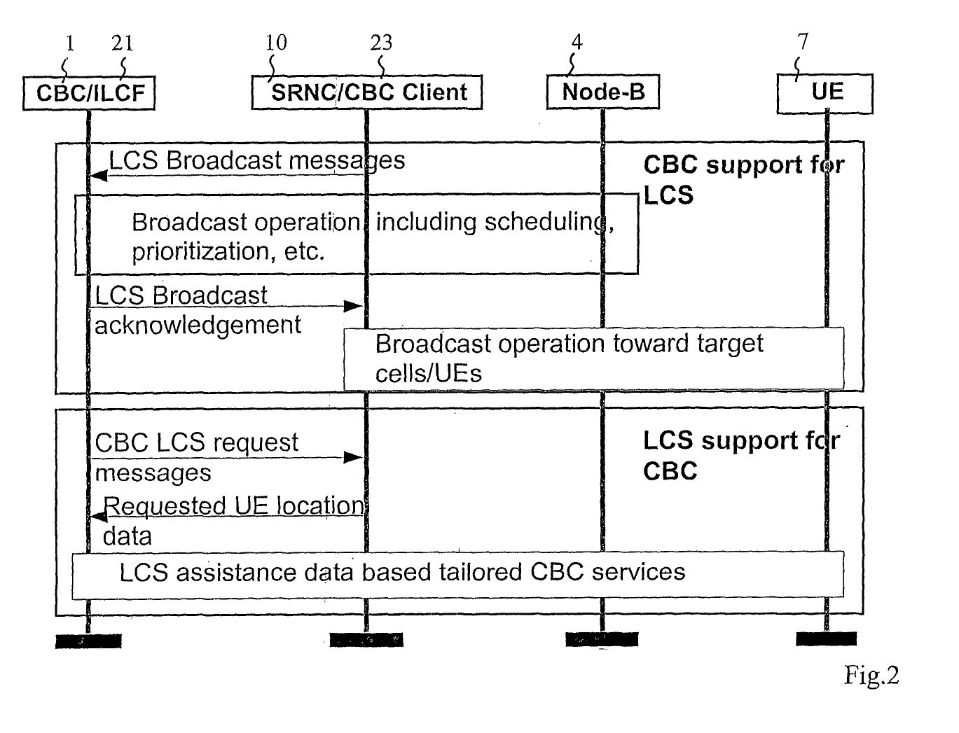

Two different possible inter-mode LCS-CBC operation procedures are illustrated in FIG. 2. In the following it is assumed that a LCS internal client entity (ILCF) 21 is integrated in the CBC 1 and that a CBC client entity 23 is integrated in the SRNC 10, respectively. It should be appreciated, however, that the internal LCS and CB clients can also be located in other appropriate network elements to which the service provider may have access rights, such as in the GMLC 12. However, because the LCS internal client 21 is assumed to be an authorised UTRAN internal user it may be advantageous to integrate these entities in the CBC 1 and the SRNC 10, respectively. This may assist further in the provision of seamless interoperation between the LCS and CBC elements of the radio access network.

As shown in the upper portion of FIG. 2, the SRNC 10 may send a broadcast activation message to the CBC 1 when necessary. The LCS broadcast message may include, in addition the data to be broadcast, data about scheduling priorities, information categorisation classes, target cells or any other assistance data that may be required and/or other relevant information. The assistance data may include any data that may be needed by an application, such as a rough location of a mobile station, any information required by an OTDOA (Observed Time Difference of Arrival) and/or IPDL (Idle Periods in Downlink) functions, information regarding the location of the base station sites used for producing measurement information, and so on. For example, Global Positioning System (GPS) assistance data may be broadcast to a substantially large area covered by a number of base stations. The assistance data may also be related to more specific operations of the location service, like the Idle Periods in Downlink (IPDL) mechanism, measurement event triggering, invoking of position of all (or predefined) mobile stations within a certain geographical area and so on.

Upon the reception of the location service (LCS) broadcast message, the CBC 1 starts transferring data to be broadcast to the SRNC 10 for the actual broadcasting operation. A possible broadcasting procedure is specified in the CB and RRC (radio resource control) specifications. The CBC 1 may send a ‘successful’ or ‘unsuccessful’ acknowledgement to the SRNC, although this is not a necessity in all applications.

The assistance data broadcasting may also to be triggered periodically by the SRNC 10, e.g. based on predefined SRNC parameters. The triggering may also be accomplished by another cell broadcasting client than the SRNC 10. However, for clarity reasons, no other clients or other possible triggering entities are shown.

According to another embodiment shown in the lower portion of the signalling flow chart of FIG. 2 and flowchart of FIG. 3, the LCS node in the controller 10 may provide assistance data for the CBC 1. This type of operation will now be exemplified by the following possible implementations thereof.

In an exemplifying application the CBC is enabled to gather the mobile location data. Instead of or in addition to the CBC, the mobile location data may be gathered by a service provider who may access to the SRNC/SMLC location service entities. Based on the gathered data the entity gathering the data may then retail or otherwise provide services for mobile stations. The service provision may be based on any appropriate predefined criteria or condition.

In conventional arrangements the CBC or the service provider may have been enabled to get mobile location data via the Gateway Mobile Location Centre (GMLC) 12 of FIG. 1, said GMLC being connected to SRNC 10 via the MSC 11 or SGSN 9. Instead, in this embodiment the SNRC 10 may send the location information regarding a target mobile station that is detected to be located within a targeted area directly to the CBC 1. Thus it may not be necessary to route the location information via one or several of the core network elements. After the CBC 1 or other service provider has received the location information from the SRNC/SMLC, it may broadcast e.g. localised information to the target mobile station.

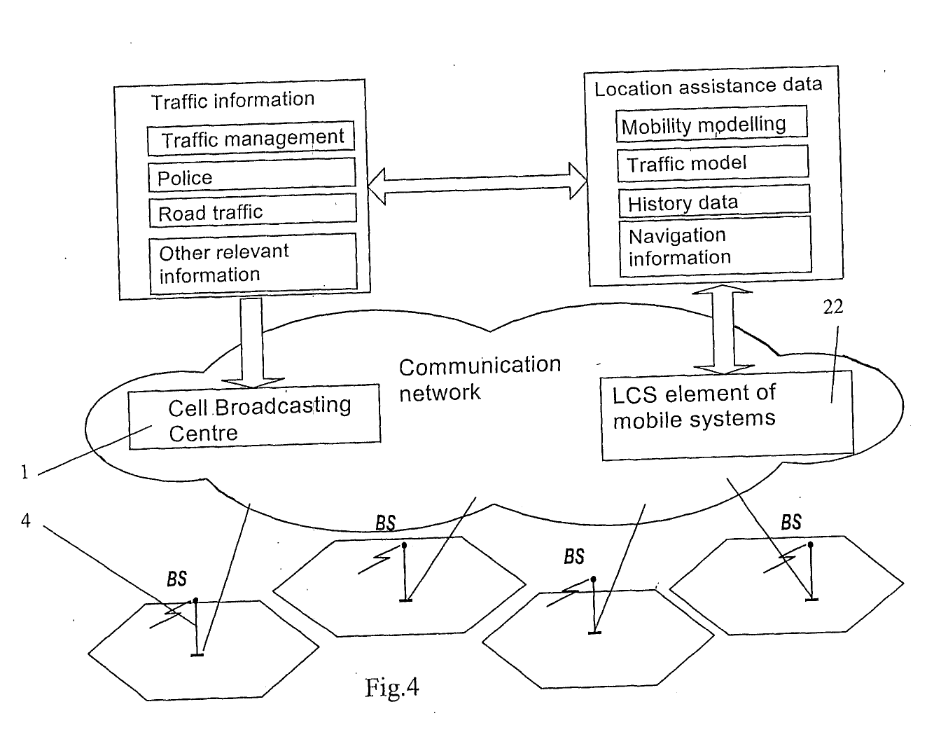

To give an example, traffic information may be broadcast based on the data that relates to the area where the most movable mobile stations are currently camping. According to one possibility those mobile stations that are determined to be the most movable stations can be concluded to be those mobile stations that are not influenced by a traffic jam. Correspondingly, those mobile stations that are not moving and/or move only slowly can be concluded to be affected by a traffic jam. A possibility for the speed determination computations is discussed below with reference to equations 4 and 5. FIG. 4 illustrates the general principle of the embodiments in which the assistance data is used for the provision of traffic related services.

In a possible application, the mobile station location data may be utilised for optimising radio resource management mechanism of the communication system. This can be achieved by means of interoperation between the radio access controller function and network planning. The network planning may refer to the original planning phase of a new network or an upgrade of the network. The upgrade may also be based on a dynamic optimisation procedure. The interoperation may be supported by the cell broadcasting function. The Following section describes examples of the use of location data internally for the radio access system to improve its self-organising capabilities with regard to the radio resource management and handoffs.

A part of the radio resource management tasks relates to handoff of mobile stations between base stations. The location assistance data may be applied for optimising the handoff events. This may include different types of handoffs, including hard, soft, softer, and soft-softer handoffs. Unlike conventional handoff procedures, in the ‘Intelligent Mobile Position-based Handoff’ (IMPH) procedure proposed herein the handoff decision can be made based on the mobile location information. As explained above, the mobile location information may be available in the radio access network controller (RNC), serving mobile location center (SMLC), or gateway mobile location center (GMLC). Therefore, it may be advantageous to use the already existing location data as a base for the handoff decision making procedures and for steering the mobile stations to be handed off to the suitable target cells or traffic areas.

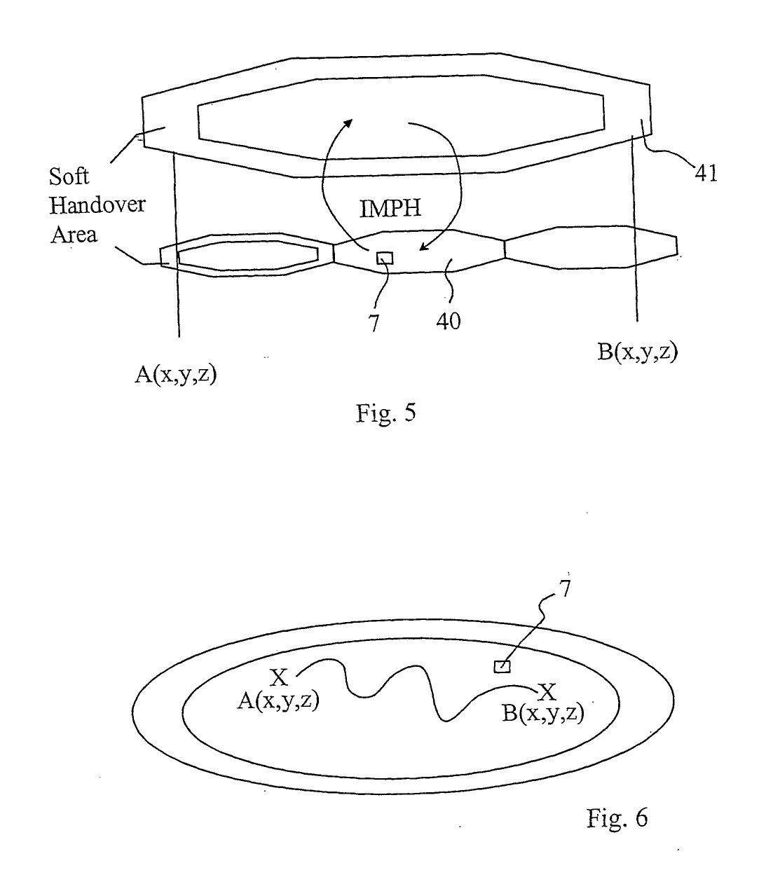

For example, with reference to FIG. 5, lets assume that a mobile station 7 is accommodating at a micro cell 40 in an network architecture where a macro cell 41 is overlaying the micro cell cluster. The real time radio network configuration data is available in the UTRAN/BSS. On the other hand, the mobile station location information can be extracted from the LCS entities of the system. These entities include any associated network element and also the mobile station. The information may include the latest available location data. Alternatively, a mobile positioning procedure may be triggered to obtain the most recent location information. The cell broadcasting function may be used to broadcasting the data to inform the target mobile stations to be positioned or handed over. Then, by comparing the location of the mobile station 7 located at a micro cell 40 sequentially or following the handoff frequency, the radio network controller may steer the mobile station 7 to the overlaying macro cell 41, or to another underlying micro cell, respectively. In pseudo-code, the decision procedure can be expressed as:

| | | |
|---|---|---|
| {if | A(x, y, z) < MS_Location < B (x, y, z) or | (1) |

| | |
|---|---|
| A(r, φ) < MS_Location < | (2) |
| B(r, φ) and Rxlev_ncell > | (3) |
| rxlev_min (n) then go to the | |
| target cell} | |

In the above algorithm, equation (1) or (2) may represent a portion or portions of a micro cell or a macro cell on top or below of a micro cell, respectively, that the handoff is possible to another macro or micro cell, respectively. Equation (3) may be used to ensure that the signal strength of the neighbouring cell (the target cell) is higher than the serving cell and that the quality of service (QoS) is guaranteed in the new cell.

For example, when a mobile station is located within an area where, according to the mobile station's location data, an inter-frequency (inter-system) handoff is possible or required, then the network elements that enable data broadcasting and handoff control in the system may send a request to the mobile station to start an inter-frequency handoff measurement procedure. The handoff decision may be made based on the measurement results and also additional mobile positioning parameters. The positioning parameters can be alternatively embedded on the handoff parameters.

Additionally, based on the latest changes in the location of the mobile station it is possible to figure out whether the mobile station moves fast or slowly and/or the speed of the change in location thereof. By using the two most recent location (e.g. in co-ordinates) of the mobile station it is possible to determine the likely travelling distance and direction of movement of the mobile station. It is also possible to determine the average speed between the two locations. These two procedures may be expressed by:

$$\begin{matrix}D = \sqrt{{( {x}_{2} - {x}_{1} )}^{2} + {( {y}_{2} - {y}_{1} )}^{2}} + ϵ \\ {V}_{m} = \frac{D}{T}\end{matrix} \qquad ( 4 , 5 )$$

wherein

D is the distance,

x,y denote the first and second location in xy co-ordinates,

ε (epsilon) depicts the error due to the randomness of the mobile station's trace and radio wave propagation characteristics,

Vₘ denotes the speed, and

T is time.

The likely velocity (vector) of the mobile station may be determined by combining the information about the speed and direction. The more frequently the mobile station is positioned the more precise value may be obtained for the distance D and speed Vₘ. If a fast change occurs between the most recent mobile station location while a long distance D is calculated, then it is clear that the mobile station moves with a substantially high speed.

In order to avoid occurrence of a too frequent handoff triggering the mobile station can be directed or handed over to a macro cell instead of handover to another micro cell. That is, although the mobile station should be handed over to the neighbouring micro cell, a decision can be made that the mobile station is handed over to the larger macro cell for the time the mobile station is moving fast. After the movement has slowed down below a predefined threshold level the mobile station can be handed over back to the micro cell level.

The location assistance data can also be efficiently used to combat so called “corner effect” which is a problem in a cellular network environment. An example of corner-effect situation is illustrated in FIG. 8. Lets assume that a mobile station 7 is moving from point A where the station has an access to the serving base station 4. As the mobile station 7 moves towards the intersection the power received by the station gradually degreases. At the intersection the mobile station turns toward a direction where there is another base station 4′. The mobile station 7 has not had a previous connection with the new base station 4′ because of Non-Line-Of-Sight (NLOS) before the corner. On the other hand, the mobile station may have also lost the Line-Of-Sight (LOS) with the serving (previous) base station 4. In such cases, mobile location assistance data may form a valuable information to approach the problem preventively. When the mobile station 7 has still LOS with the serving cell, its location co-ordinates, speed, and possibly direction can be estimated by the network or the mobile station itself. As the mobile station approaches the neighbouring cell or as the signal received from the home cell becomes weaker the mobile station 7 may start measuring the signal strength of the nearest neighbouring base station. Practically, this means that in the case of a soft handover the neighbouring base station's signal is put into the active set even though the signal may reach a threshold level for the soft handoff active set. In a hard handover this means that the handover may be executed even though the signal from the neighbouring cell does not reach the threshold set for the hard handover.

The pre-emptive approach may be applied for the above discussed IMPH embodiments as well. In that case a mobile station moving e.g. to a street corner can be handed over to the macro-cell in order to avoid sweepy power deterioration condition at the street corner.

It should be appreciated that in addition to the handoff the distance and velocity information obtained by means of the location service may be used for various other purposes. An example of such application is the use of the information for follow up of vehicle speeds. A possible application of this was discussed with reference to FIG. 4. This may be accomplished by means of a functionality that is integrated to a telematic device that is assembled to a vehicle, such as a car or a boat. The telematic device refers to a device which handles the communication functionality i.e. the mobile station that is used in the vehicle.

In general, in an IMPH procedure a target cell can be any appropriate radio access entity, such as a macro cell, a micro cell, a pico cell, a low traffic cell, a cell within a private coverage with reduced tariff, a cell within location service coverage (to position the mobile station by the network), an indoor/outdoor cell within other networks and so on.

The signalling procedures in an IMPH implementation may follow the level of handoff hierarchy in the system architecture and can be mainly based on the existing handoff signalling procedures with an additional LCS supporting procedure. The IMPH embodiments may also be utilised as a complementary part of different handoff procedures.

In the soft handoff (SHO), the LCS data can be utilised to optimise the active set areas. The term ‘active set’ refers to set of radio links that are simultaneously involved in a specific communication service between a mobile station and one or several network elements. When the soft handoff area is initialised, in addition to traditional soft handoff measurements, the location information may be used for the first estimates regarding the extent of the SHO area. Moreover, LCS data can be utilised to optimise the SHO configuration dynamically as the traffic and mobility aspects of the network environment change. Furthermore, if a number of mobile stations camp in a cell, moving around the inner limit of the SHO area forward and backward to the active set and non-active set area (see FIG. 6), then the LCS data may be used as background information to optimise the SHO range changes. Otherwise they may cause the SHO triggering too often, resulting in undesirable signalling load to the system and decreasing the system performance. In these specific instances, which may happen very frequently e.g. in the radio access network (RAN) of the 3G WCDMA, by using the LCS data, the extent of the SHO can be adjusted such that the so called “Ping Pong” effect may be avoided. The “Ping Pong” effect is disadvantageous as it causes undesirable additional processing in the branch addition, deletion, and replacement mechanisms. The expanse of the SHO are can be adjusted for neighbouring cells within the radio network based on the location data of the mobiles dwelling at the soft handoff areas of the neighbouring cells. FIG. 6 shows an example of the random trace of a mobile station 7 in a soft handoff boundary between locations A and B.

The soft handoff (SHO) range adjusting may mutually facilitate the mobile station positioning process in instances where the system load is high or there is lack of branches that are needed for the network-based location processes. In addition to that, if the requested location service cannot be fulfilled because of high signalling load in the system, additional signal branches may be deleted (SHO range downsizing).

Radio network controller (RNC) may have the main responsibility of the control of the location service, broadcasting mechanism, as well as the radio resource management (RRM). Thus the utilisation of the LCS data in the RRM optimisation process may be seamlessly implemented in a cellular system that correspond the third generation systems.

The LCS data may also be used for adjusting the transmission power. In case of an open loop power control (OLPC) the pilot signal thereof may be adjusted based on the mobile station location data. For example, when most mobile stations are determined to be located close to a base station, the pilot signal level can be decreased. Alternatively, dedicated pilot signals may set the most reasonable power level based on the mobile station location data.

The LCS data may also be used for downlink transmission power adjustments to provide support for an adaptive cell coverage adjustment. That is, the distribution of the mobile stations (e.g. hot spots) can be figured out based on the LCS data. By using this information the base station transmission power can be adjusted adaptively to support the required radio coverage. This ensures that the radio coverage is spread efficiently to the locations where the mobile stations are. The LCS data may also be used for adjusting the idle periods of the base station transmission e.g. in the Downlink Idle Period mechanism.

As far as the uplink (UL) is concerned, in a mobile-based positioning method, the mobile station may be adapted to calculate its own position. The LCS data can be utilised to adjust the mobile stations transmission power at least for setting the first value (or a value that associates with outer loop power control).

In addition, the mobile station may save the most frequent power level of its transmission signal at specific area or zone (expressed e.g. in co-ordinates). Such information may be used later for adjusting the transmission signal power levels. That is, when the mobile station re-enters to the same zone/area its power may be fitted to the pre-reference margin. So, the LCS data can be used to determine the zone-based transmission power margin, which can be a complementary information, for instance, for outer loop power control step setting.

Moreover, when a mobile station is moving towards a location where the mobile station may experience a very fast power dropping/raising (e.g. a street corner between tall buildings), a pre-emptive power approach can be applied based on the mobile station location data. That is, the mobile station transmission power may increase/decrease gradually before it actually arrives at said location. Alternatively, the transmit power may be kept unchanged based on the determination that soon there will probably be another LOS (line of sight) request from the neighbouring base station to add the signal quality.

The following examples will clarify in more detail the advantages the LCS data may bring to the RRM optimisation process when considering the operation from the point of view of the admission control and packet scheduled entities.

The LCS data may be used for determination of the traffic distribution within the network. For example, the most possible requested bite rate within specific area, where a mobile station is camping in, is valuable data that may be obtained by using the LCS data and the history data of the traffic distribution. An example of this is hot spot determination.

The relation between the fulfilled handoffs, mobile station mobility, and call blocking can be optimised more efficiently by using the LCS data along with data broadcast supporting. This information can be used also for optimising Admission Control parameters in the radio access network system. Those mobile stations with variable movement may be admitted directly to the appropriate cells (cells which the mobile station is determined to enter/approach based on the direction of movement) even if the mobile station (MS) is not moving especially fast at the time of requesting the service. The neighbouring resources can be reserved beforehand and the home cell resources may be kept for other purposes. High data rate mobile stations may be admitted to the most appropriate cells. This is referred to herein as ‘cold spot’ finding. The cold spot finding provides a short radio link distance or a better signal link for the mobile station. The cold spot finding may be used to prevent mobile stations to enter cells which may cause more interference to the system or which cannot meet the desired QoS for the high bit rate traffic. This may be the case, for instance, when high bit rate mobile stations are located rather close to the edges of a cell.

Services may be categorised based on the mobile stations' location. Alternatively, mobile stations' location may be used as an additional criteria for admission decision making. Therefore, based on the bearer requested and service provided within the area the best available access may be allocated to the mobiles.

Data from the admission control function, the load control function, a data packet scheduler/sorter, and the location service may be used as basis for broadcasting the available radio resources at a certain area. The area may be an area where the mobile station is expected to request radio access or the mobile station is required to configure a Radio Access Bearer (RAB). For example, data transmission capability of the network within a specific area can be broadcast to a mobile station entering to the area or that is already camping the area based on information of the available network resources.

The mobile station location data may be utilised in a multi-system environment such that radio bandwidth may be used more efficiently during the access decision steps, thus avoiding additional or unnecessary handoffs.

LCS data may also be used for scrambling and channel code planning for WCDMA radio resource management. LCS data may be used as an input data for the purposes of the code planning and radio network layout planning because there is typically a close dependency between mobile stations' location and mobility, and these planning operations. For example, based on the mobile station location data the original uplink (UL) code allocated to the mobile station may be blocked, excluded, or allowed to be simultaneously used in a specific period of time in neighbouring cells to avoid a possible code collision between different mobile stations camping in neighbouring cells. In case of downlink (DL), the location data may be utilised for spreading factor (SF) determination and code orthogonality correction.

If multi-component (multi-bearer) radio accesses are employed, LCS may be utilised to allocate the most appropriate available radio resources for the requested services. For example, based on the QoS of the different call components, the corresponding cell resources are allocated for these components. In addition to that, different call components may be blocked, or handed over based on the QoS of these components, LCS data, radio measurements, and radio resources in an overload state. By this the AC (Admission Control) can improve the network stability and increase the access probability.

The embodiments of the invention may also be applied in mobile ad hoc networking. The concept of mobile ad hoc networking refers to the network environment like mobile IP, in which a number of portable devices (referred to nodes in this context) with wireless interfaces gather together in a place where no actual cellular wireless infrastructure is available (i.e. no connection to a base station is available). In such an environment, the devices themselves may set up and maintain a communications network. If two mobile nodes are not within the communication range, intermediate nodes have to forward the data traffic between said two mobile nodes. Since all these devices may be portable or mobile, the network topology may change dynamically. That is, every node may act as a router in a wireless mobile environment. The embodiment enables a mobile station that may not hear the base station but that may hear the intermediate node to receive data from the network, the intermediate node being responsible for routing data to the mobile station. Moreover, if there are connections between a router and mobile stations which are not the most optimised ones then the information regarding the more optimal routers can be broadcast to the related nodes.

The essential element of mobile ad hoc networking is the routing technology applied for the routing protocol structure. Furthermore, the backbone of every routing technology is the route discovery approach. Different route discoveries have been applied for mobile ad hoc networking. When an incoming call arrives at the source node S for destination node D and there is no route available to rout the packet to D, S initiates a rout discovery phase. Here, S has two options; either to flood the network with a route query in which case the route query packets are broadcast into the whole network; or instead, to limit the discovery in a smaller region of the network, if some kind of location information prediction model for D can be established. The LCS data may be used to optimise the traffic routing from the traffic source (e.g. base station) to the destination. We describe the basic idea of LCS-based Routing Discover (LRD) by following principles: A mobile station terminated radio access arrives to the radio access apparatus. The destination device is paged and positioned by using the LCS technologies already specified for GSM and UMTS. This data may already be available for other applications in the network side (e.g. in RNC). Based on the position of the termination device (e.g. mobile) and the changes in its co-ordinates, as well as the available positioned routing nodes within the communication range the most optimised path is chosen by the radio access network to transport the packet data between the two end nodes.

In case of traffic routing, the routing node may be reselected on fly (referred to herein as inter node handover) in order to optimise the routing path and decrease the interference caused by routed traffic. Similar approach can be applied for any routing node-based techniques using in the cellular system. One example of the cellular relay technique is Opportunity Driven Multiple Access (ODMA) proposed for the WCDMA system. In the same manner as mentioned above LCS data can be utilised for node probing in ODMA scheme. The routing optimisation is considered as important task in an interference limited wireless environment like CDMA.

The interoperation of the LCS, CB, and radio planning is a basis for providing intelligent radio resource management, enabling self-learning radio resource management to the radio access system.

In an application of the second embodiment of the FIG. 2 signalling flowchart, the CBC 1 can broadcast tariff related information to mobile stations based on their location and the services the mobile stations may use more frequently. For example, this may be applied to services that require high data rates, localised services, and so on.

In an application of the lower embodiment of FIG. 2, a service provider may define geographical areas where certain services or service aspects are available to those mobile stations only that are located inside this geographical area. The service provider sets the information about the geographical areas in the CBC 1. The CBC 1 may then broadcast this information over all radio cells that cover at least parts of this geographical area. The mobile station or the network may determine the position of the mobile station regularly and notify the service provider or LCS client when the mobile station enters the defined geographical area and/or leaves the geographical area. The service provider or other client receives the notifications and may then activate or deactivate a given service or service aspect based on the notifications.

The service aspect may comprise a tariff that is applicable for a service or another service aspect within the defined geographical area.

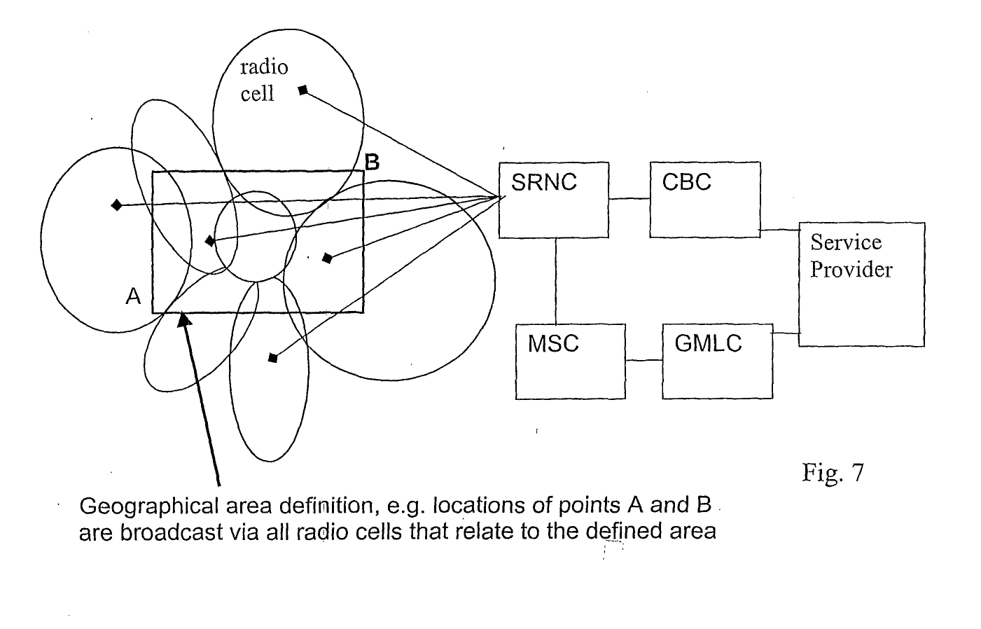

One example of the above application is local broadcasting that contains local information. Push services are also possible, so that the mobile will be offered local information, when it is entering the geographical area. The principle of this type of applications is illustrated in FIG. 7. The geographical area definition may consist e.g. of the geographical locations of points A and B. A possibility is that the geographical area definition is based on one of several of shapes such as the ones defined in the 3GPP TS 23.032. This information may be broadcast via all related radio cells (i.e. in cells that provide a full or at least a partial coverage of the geographical area) or via predefined related radio cells. If only one point A is given the geographical area definition indicates the central point of a circle together with the achievable measurement accuracy (e.g. 100 meters) as the radius of the circle. This “one point area” represents the smallest area that may be defined.

According to an embodiment the geographical area definition (e.g. in accordance with the DEGA) is stored at a memory means of the mobile station, such as in a SIM or USIM thereof.

Each defined geographical area may be assigned with a unique identifier. The unique identifier may be assigned at the system planning stage or the service provider may assign the identifier later on. The identifier may then be displayed to the user of the station. Instead of the unique identifier, other identifier, such as a name of the geographical area may be displayed or otherwise informed to the user. The information may be displayed after it has been detected that the station has entered the defined geographical area.

The user of the station or other party, such as the service provider, may be enabled to activate or deactivate the sending of the notification to the service provider or other client. The selection may be done with regard to individual notifications or the sending thereof may be switched between active and deactive modes. The user of the station may use the keypad of other user interface of the station to select whether the sending of the notifications should be in active or deactive mode.

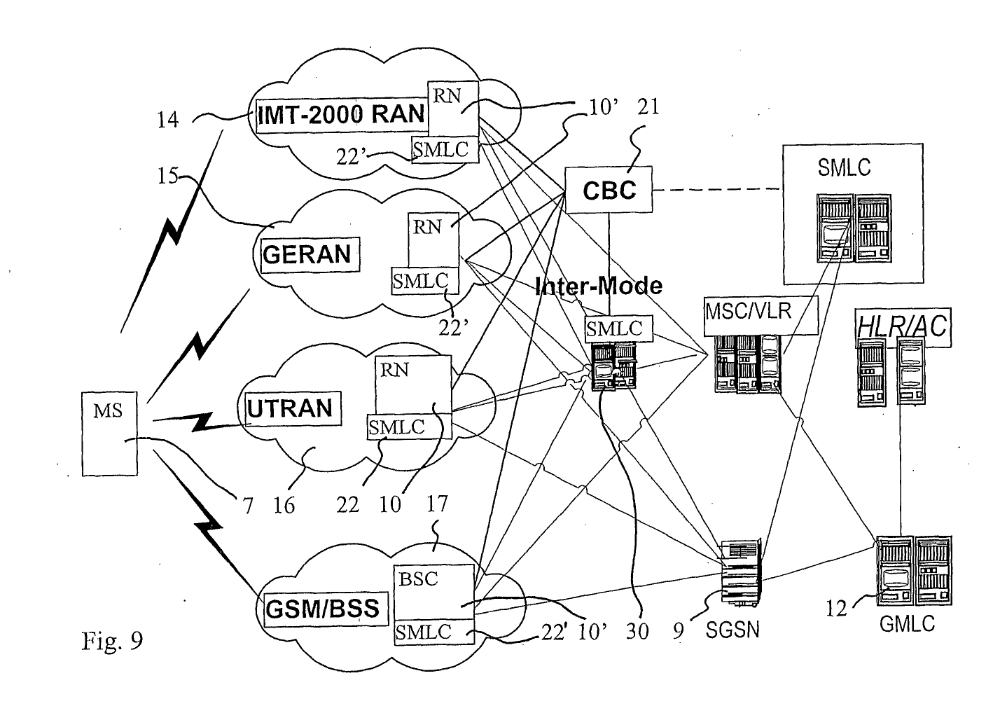

FIG. 9 illustrates a communication system comprising several different types of radio access networks. More particularly, the FIG. 9 system comprises a radio access network (RAN) 14 of a third generation IMT-2000 system, a second generation GPRS/EDGE radio access network (GERAN) 15, a third generation UMTS Terrestrial Radio Access Network (UTRAN) 16 and a radio access network 17 of a conventional GSM system. The GSM access network is typically referred to as a base station subsystem (BSS). The mobile station 7 of FIG. 9 is shown to be able to communicate with all of the different access systems 14 to 17. However, it should appreciated that this may not always be the case. For example, the mobile station may be a dual mode mobile station capable of communication with only two of the access networks. This is an implementation issue.

In an embodiment the CBC element 21 may communicate with different access network controllers 10, 10′ of the different access networks. For example, the CBC 21 is capable to communicate with the base station controller (BSC) 10′ of the GSM and the UTRAN RNC 10 of the UMTS. This enables the CBC 21 to broadcast all information or selected information in all possible network systems. It is also possible to broadcast only in selected systems (e.g. only in the GSM and in the UMTS).

Each of the access network controllers 10,10′ may be provided with a “local” serving mobile location centre function 22,22′. The core network is provided with a common location service node 30 that is capable of handling the communication from and to the appropriate “local” access network entities in a multi-system environment. The “local” location service entities 22,22′ may be integrated with the respective access network controller 10,10′. The local location service function 22,22′ and the network controller 10,10′ may also be separate entities that interface each other.

It should be appreciated that mobile stations that are provided with different positioning capabilities or are adapted to communicate in accordance with a different standard may interpret the area definitions in different ways.

The above described embodiments employ active and mutual interaction between the Cell Broadcasting Centre (CBC) and the Location Services (LCS). This may be implemented by integrating an internal LCS client (ILCF) in the CBC and a CB client in the access network controller. Such an enhanced interaction may benefit Radio Resource Control by introducing cell broadcasting as a method for system information broadcasting, thus saving BCCH (broadcast channel) resources in the access network level of the system. Furthermore, the interaction may establish a basis for advanced cell broadcast applications for e.g. telephone network operators and other service providers. These application may utilise the mobile location data in an improved manner. The embodiments may save UTRAN broadcast channel resources and provide a means for geographically selective broadcasting applications conducted by the cell broadcasting centre without significantly affecting the network architecture or necessitating modifications in any of the standardised interfaces.

The cell broadcasting may also offer a valuable possibility to combat the resource scarcity in the communication system. A reasoning for this is that the cell broadcasting may operate in a point to multipoint configuration, which enables communication to many chosen cells at the time of broadcasting. The cells may be controlled by different radio network controllers. It may also be advantageous to integrate the cell broadcasting and location service functionality in the radio system to improve these functions by their mutual co-operation.

It should be appreciated that whilst embodiments of the present invention have been described in relation to mobile stations, embodiments of the present invention are applicable to any other suitable type of user equipment. It should also be appreciated that while the above describes exemplifying embodiments of the invention, there are several variations and modifications which may be made to the disclosed solution without departing from the scope of the present invention as defined in the appended claims.

1. A method in a communication system provided with a plurality of access entities for provision of wireless communication for stations within the service area of the access entities, and a broadcasting element adapted to control broadcasting within at least one of the access entities, comprising:
generating information that associates with the location of a station and processing said location information in a location service function;
communicating information between the location service function and the broadcasting element; and
broadcasting in selected access entities based on information communicated between the location service function and the broadcasting element.

2. A method as claimed in claim 1, wherein the processing in the location service function comprises storing the location information.

3. A method as claimed in claim 1 or 2, wherein the location service function is integrated with a controller adapted to control at least one of the access entities and serving the station within the at least one access entity.

4. A method as claimed in any preceding claim, wherein a first client is implemented in the broadcasting element for enabling the location function to access the broadcasting element.

5. A method as claimed in claim 4, wherein the first client comprises a location service function client.

6. A method as claimed in any preceding claim, wherein the broadcasting element is enabled to access the location service function by means of a second client.

7. A method as claimed in claim 6, wherein the second client comprises a cell broadcasting client.

8. A method as claimed in claim 6 or 7 when appended to claims 2 and 3, wherein the second client is for accessing information stored at the location service function of the controller serving the station.

9. A method as claimed in any preceding claim, wherein said broadcasting is used for broadcasting system information.

10. A method as claimed in claim 9, wherein the system information broadcasting is controlled by a radio resource control function based on information from the location service function.

11. A method as claimed in any preceding claim, wherein information broadcasting in one or several of the access entities is controlled by the broadcasting element based on said location information.

12. A method as claimed in claim 11, wherein the selection of broadcasting areas is based on said location information fetched from the location service function.

13. A method as claimed in any preceding claim, wherein information is broadcast only in access entities that have been selected based on the location information.

14. A method as claimed in any preceding claim, wherein the information communicated between the location service function and the broadcasting element comprises location assistance data.

15. A method as claimed in any preceding claim, wherein the controller comprises a radio access network controller, the location service function is associated with the controller and the location service function and the broadcasting element communicate directly with each other.

16. A method as claimed in any preceding claim, wherein the location information is used for radio resource management.

17. A method as claimed in any preceding claim, wherein the location information is used as assistance data in handoff procedures between different access entities of the communication system.

18. A method as claimed in claim 17, wherein a selection whether the station should be transferred to a micro cell or a macro cell is based on the location information.

19. A method as claimed in any preceding claim, comprising determining the distance the station has moved within a certain period of time based on the location information.

20. A method as claimed in any preceding claim, comprising determining an average speed of the station within a certain period of time based on the location information.

21. A method as claimed in claim 19 or 20 wherein at least one of the following information is taken into account during a handoff decision making procedure: information of the distance; information of the speed; information of the direction of movement of the station; information of the velocity of the station.

22. A method as claimed in claim 19 or 20 wherein of the distance and/or the speed and/or direction of movement and/or velocity is used for services that associate with vehicle traffic.

23. A method as claimed in any preceding claim, comprising adjusting power levels in at least one of the access entities based on assistance information provided by means of the location service function.

24. A method as claimed in any preceding claim, comprising determining distribution of stations within at least one of the access entities based on assistance information provided by means of the location service function.

25. A method as claimed in any preceding claim, comprising categorising stations within at least one of the access entities based on assistance information provided by means of the location service function.

26. A method as claimed in any preceding claim, comprising broadcasting tariff related information within at least one of the access entities based on assistance information provided by means of the location service function.

27. A method as claimed in any preceding claim, wherein the information that associates with the location of the station is determined at the station.

28. A method as claimed in any preceding claim, comprising:
defining a geographical area where a certain service or service aspect offered by a service provider is available to stations within said area;
broadcasting information that associates with the defined geographical area by the broadcasting element in at least one access entity that belongs at least partially to said geographical area;
sending a notification to the service provider or another client to indicate that the station has entered or left the defined geographical area; and
activating or deactivating the service or the service aspect for the station based on the notification.

29. A method as claimed in claim 28, wherein the geographical area definition is stored at a memory means of the station.

30. A method as claimed in claim 28 or 29, wherein the service aspect comprises a tariff that is applicable for a service or service aspect within the defined geographical area.

31. A method as claimed in any of claims 28 to 30, comprising the steps of:
assigning each defined geographical area a unique identifier; and
displaying information based on the unique identifier after the station has entered the defined geographical area.

32. A method as claimed in claim 31, wherein the information is displayed to the user of the station by means of the station and comprises the unique identifier or other identifier of the geographical area.

33. A method as claimed in any of claims 28 to 32, comprising step of activating or deactivating the sending of the notification to the service provider or other client.

34. A method as claimed in claim 34, wherein the user of the station may select whether the sending of the notifications is in active or in deactive mode.

35. A method as claimed in any preceding claim, wherein the broadcasting element communicates with controllers of at least two different access networks.

36. A method as claimed in claim 35, wherein the broadcasting element communicates with at least one GMS access network controller and at least one third generation mobile communications system access network controller and wherein at least part of the information is broadcast both in the GSM system and in the third generation communication system.

37. A method as claimed in any preceding claim, wherein a first location service function associates with a first access entity of a first communication system and a second location service function associates with a second access entity of a second communication system, and wherein the first location service function and the second location service function communicate with a common location service node.

38. A method as claimed in any preceding claim, comprising optimisation of handoff ranges based on location information provided by means of the location service function.

39. A method as claimed in any preceding claim comprising data transmission that is based on ad hoc networking between two stations.

40. A communication system, comprising:
a plurality of access entities providing wireless communication facility for stations;
a broadcasting element adapted to control broadcasting within at least one of the access entities;
a location service element that associates with a controller adapted to control at least one access entity for processing information that associates with location of a station; and
means adapted to communicate information between the location service element and the broadcasting element,
wherein the communication system is arranged to broadcast in selected access entities based on the information that has been communicated between the location service element and the broadcasting element.

41. A communication system as claimed in claim 40, wherein the location service function is integrated with a serving radio access network controller.

42. A communication system as claimed in claim 40 or 41, wherein a first client is implemented in the broadcasting element for enabling the location service element to communicate with the broadcasting element.

43. A communication system as claimed in any of claims 40 to 42, comprising a second client for enabling the broadcasting element to fetch information from the location service element.

44. A communication system as claimed in any of claims 40 to 43, wherein the broadcasting element is adapted to control system information broadcasting based on information from the location service element.

45. A communication system as claimed in any of claims 40 to 44, comprising a common location service node adapted to communicate with elements of access networks of at least two different communication networks.

46. An arrangement for a communication system comprising:
a first client for use in a broadcasting element of the communication system for enabling a location service function of the communication system to access the broadcasting element; and
a second client for use in the location service function for enabling the broadcasting element to access the location service function,
wherein the clients enable interaction between the location service function and the broadcasting element over an interface there between.

47. An arrangement as claimed in claim 46, wherein the location service function is integrated with a controller adapted to control at least one access entity of the communication system.
